(19) United States
(12) Patent Application Publication
(10) Pub. No.: US 2013/0062561 A1
(43) Pub. Date: Mar. 14, 2013

(54) PHOSPHOR AND METHOD OF PREPARING THE SAME

(71) Applicants: Wei-Ting Chen, New Taipei City (TW); Ru-Shi Liu, New Taipei City (TW); Chien-Yuan Wang, Kaohsiung City (TW)

(72) Inventors: Wei-Ting Chen, New Taipei City (TW); Ru-Shi Liu, New Taipei City (TW); Chien-Yuan Wang, Kaohsiung City (TW)

(73) Assignee: EPISTAR CORPORATION, Hsinchu (TW)

(21) Appl. No.: 13/228,468

(22) Filed: Sep. 9, 2011

(51) Int. Cl. C09K 11/78; C09K 11/57; C09K 11/77

(52) U.S. Cl. 252/301.4 R

(57) ABSTRACT

A phosphor is represented by below formula:

AₐB_{b}C_{c}D_{d}Eₑ:Mₘ
wherein, M represents at least one activator selected from Mn, Ce, Pr, Nd, Sm, Eu, Tb, Dy, Ho, Er, Tm, Yb and combinations thereof; A represents at least one element selected from Ca²⁺, Sr²⁺, Ba²⁺ and combinations thereof; B represents C⁴⁺, Si⁴⁺ or Ge⁴⁺; C represents B³⁺, Al³⁺ or Ga³⁺; D and E each independently represent at least one element selected from N, O, F and combinations thereof; m+a=2; 0.00001≦m≦0.1; 0.5≦b+c≦8; and 0.5≦d+e≦10. The phosphor has a color render index of greater than 50 and is suitable to be applied in a white LED to improve the color rendering property of the white light. A method of preparing the phosphor is also provided.

### BACKGROUND OF THE INVENTION

1. Field of Invention

The present invention relates to a phosphor and a method of preparing the same, and more generally to a red nitride phosphor and a method of preparing the same.

2. Description of Related Art

In recent years, due to the promising green technology, a white light emitting diode (white LED) with the advantages of energy-saving, small size, low driving voltage and mercury-free has been widely used in common illumination devices and backlight modules of flat display. It is known that a phosphor plays a significant role in a white LED. Therefore, different phosphors have been developed so as to enhance the light emitting performance of a white LED.

In one conventional white LED, a cerium-doped yttrium aluminium garnet (YAG:Ce) is mainly adopted to convert a blue light emitted from a blue LED into a yellow light, followed by mixing the blue light with the yellow light so as to produce a white light. However, the optical spectrum of the white light produced by the blue LED and the yellow phosphor does not contain a red wavelength component.

Another kind of phosphor that can cover the range of the red wavelength is the yellow-to-red emitting phosphor represented by MₓSi_{y}N_{z}:Eu, wherein M represents at least one element selected from Ca, Sr and Ba. The yellow-to-red emitting phosphor has an emitting wavelength of 600-680 nm. However, such a yellow-to-red emitting phosphor has a color render index (CRI or Ra) of less than 50, and is not suitable to be applied in a white LED. Accordingly, a red nitride phosphor with a higher CRI is deeply desired in the industry.

### SUMMARY OF THE DISCLOSURE

The present disclosure provides a phosphor having a CRI of greater than 50. The phosphor can improve the color rendering property of the white light when used in an illumination device.

The present disclosure further provides a method of preparing the above-mentioned phosphor. The method is simple and can be implemented for mass production.

The present disclosure provides a phosphor represented by following chemical formula (1):

AₐB_{b}C_{c}D_{d}Eₑ:Mₘ (1),

wherein, M represents at least one activator selected from Mn, Ce, Pr, Nd, Sm, Eu, Tb, Dy, Ho, Er, Tm, Yb and combinations thereof; A represents at least one element selected from Ca²⁺, Sr²⁺, Ba²⁺ and combinations thereof; B represents C⁴⁺, Si⁴⁺ or Ge⁴⁺; C represents B³⁺, Al³⁺ or Ga³⁺; D and E each independently represent at least one element selected from N, O, F and combinations thereof; m+a=2; 0.00001≦m≦0.1; 0.5≦b+c≦8; and 0.5≦d+e≦10.

According to an embodiment of the present disclosure, the phosphor can be represented by following chemical formula (2):

Sr_{1.95}Si₅₋ₓAlₓN₈₋ₓOₓ:Eu_{0.05} (2),

wherein 0.25≦x≦1.00.

According to an embodiment of the present disclosure, the phosphor can be represented by following chemical formula (2):

Sr_{1.95}Si₅₋ₓAlₓN₈₋ₓOₓ:Eu_{0.05} (2),

wherein 0.25≦x≦0.75.

According to an embodiment of the present disclosure, a color rendering index (CRI) of the phosphor is greater than about 50 and less than about 70.

According to an embodiment of the present disclosure, the phosphor is excited by a first light having a dominant wavelength of about 350-550 nm to emit a second light.

According to an embodiment of the present disclosure, the second light includes a dominant wavelength of about 550-750 nm and a full width at half maximum (FWHM) of about 90-130 nm.

According to an embodiment of the present disclosure, the second light includes a dominant wavelength of about 626-635 nm and a FWHM of about 100-123 nm.

The present disclosure further provides a method of preparing a phosphor. The method includes the following steps. A mixture including precursors of Sr, Si, Eu and Al. Thereafter, the mixture is mixing and ground. Afterwards, a sintering process is performed to the mixture after being mixed and ground under inert gas atmosphere, so as to form a phosphor represented by following chemical formula (2):

Sr_{1.95}Si₅₋ₓAlₓN₈₋ₓOₓ:Eu_{0.05} (2),

wherein 0.25≦x≦1.00.

According to an embodiment of the present invention, the step of providing the mixture further includes providing Sr₃N₂, Si₃N₄, EuN and Al₂O₃.

According to an embodiment of the present disclosure, a sintering temperature is about 1,400-1,900° C. during the sintering process, for example.

According to an embodiment of the present disclosure, a sintering time is about 1-5 hours during the sintering process, for example.

According to an embodiment of the present disclosure, an inert gas pressure is about 0.3-0.9 MPa during the sintering process, for example.

According to an embodiment of the present disclosure, a sintering temperature is about 1,600° C., a sintering time is about 2 hours, and an inert gas pressure is about 0.5 MPa during the sintering process, for example.

According to an embodiment of the present disclosure, a color rendering index (CRI) of the phosphor is greater than about 50 and less than about 70.

According to an embodiment of the present disclosure, the phosphor is excited by a first light having a dominant wavelength of about 350-550 nm to emit a second light.

According to an embodiment of the present disclosure, the second light includes a dominant wavelength of about 550-750 nm and a full width at half maximum (FWHM) of about 90-130 nm.

According to an embodiment of the present disclosure, the second light includes a dominant wavelength of about 626-635 nm and a FWHM of about 100-123 nm.

In view of the above, the red nitride phosphor with a CRI of greater than 50 can be prepared with a simple method. That is, an appropriate amount of Al₂O₃ is added to the red nitride phosphor precursors, and the mixture are mixed up and then sintered to form the red nitride phosphor of the present invention. Since the red nitride phosphor with a higher CRI is easy for mass production, this red nitride phosphor can be widely applied in the industry.

In order to make the aforementioned and other objects, features and advantages of the present disclosure comprehensible, some preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method of preparing a red nitride phosphor according to an embodiment of the present disclosure.

FIG. 2 shows the X-ray diffraction spectra of the red nitride phosphors according to Comparative Example 1 and Examples 1-4 of the present disclosure.

FIG. 3 shows the excitation and emission spectra of the red nitride phosphors according to Comparative Example 1 and Examples 1-4 of the present disclosure.

FIG. 4 shows the normalized emission spectra of the red nitride phosphors according to Comparative Example 1 and Examples 1-4 of the present disclosure.

FIG. 5 is the CRI diagram of the red nitride phosphors according to Comparative Example 1 and Examples 1-4 of the present disclosure.

### DESCRIPTION OF EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

A novel red nitride phosphor is provided in the present disclosure. The red nitride phosphor has a unique chemical crystal structure that allows to emit a red light with a higher color render index (CRI). The red nitride phosphor of the present disclosure is represented by following chemical formula (1):

AₐB_{b}C_{c}D_{d}Eₑ:Mₘ (1)

wherein M represents at least one activator selected from Mn, Ce, Pr, Nd, Sm, Eu, Tb, Dy, Ho, Er, Tm, Yb and combinations thereof; A represents at least one element selected from Ca²⁺, Sr²⁺, Ba²⁺ and combinations thereof; B represents C⁴⁺, Si⁴⁺, or Ge⁴⁺; C represents B³⁺, Al³⁺, or Ga³⁺; D and E each independently represent at least one element selected from N, O, F and combinations thereof; m+a=2; 0.00001≦m≦0.1; 0.5≦b+c≦8; and 0.5≦d+e≦10.

In an embodiment, the red nitride phosphor of the present disclosure can be represented by following chemical formula (2):

Sr_{1.95}Si₅₋ₓAlₓN₈₋ₓOₓ:E_{0.05} (2)

wherein M is Eu; A is Sr²⁺; B is Si⁴⁺; C is Al³⁺; D is N; E is 0; m is 0.05, a is 1.95; b+c=5; d+e=8; and x is equal to or more than 0.25 and less than 1.00.

It is noted that the CRI of the red nitride phosphor of the present disclosure is greater than about 50 and less than about 70. The red nitride phosphor is excited by a first light having a dominant wavelength of about 350-550 nm (preferably 360-480 nm) to emit a second light. The second light includes a wavelength of about 550-750 nm and a full width at half maximum (FWHM) of about 90-130 nm.

In view of the foregoing, as the red nitride phosphor of the present disclosure can provide a red light with a higher CRI, this red nitride phosphor is suitable to be applied in a white LED to improve the color rendering property of the white light.

The method of preparing the red nitride phosphor of the present disclosure is illustrated below. The red nitride phosphors represented by Sr_{1.95}Si₅₋ₓAlₓN₈₋ₓOₓ:E_{0.05} (wherein x is equal to or more than 0.25 and less than 1.00) are taken as examples for illustration purposes and are not construed as limiting the present invention.

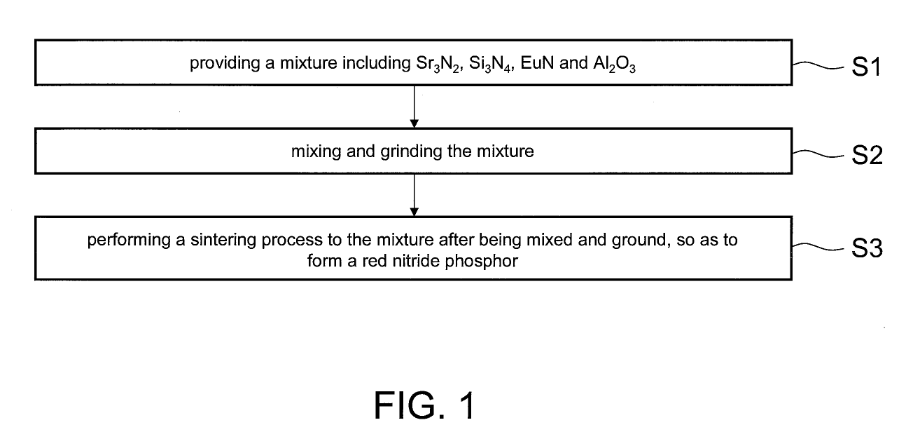

FIG. 1 is a flow chart of a method of preparing a red nitride phosphor according to an embodiment of the present disclosure. The preparing method is, for example, a solid phase synthesis carried out under an inert gas atmosphere.

Referring to FIG. 1, in step S1, a mixture including precursors of Sr, Si, Eu, and Al is provided. In an embodiment, the step of providing the mixture includes providing Sr₃N₂, Si₃N₄, EuN, and Al₂O₃ according to stoichiometry. Specifically, the composition ratio of each component of the red nitride phosphor is adjusted according to the mole fraction as shown in the formula (2).

Thereafter, in step S2, the mixture is mixed and ground. In step S2, in order to obtain a more uniform mixture, the mixing and grinding of the mixture takes about 30 minutes.

Afterwards, in step S3, a sintering process is applied to the mixture after being mixed and ground, so as to form a red nitride phosphor. When the sintering process is performed in step S3, the uniformly mixed and ground mixture is placed in a crucible, for example. The crucible is then placed in a high temperature furnace with an inert gas (e.g. nitrogen) under a pressure of about 0.3-0.9 MPa to perform the sintering process at 1,400-1,900° C. for about 1-5 hours, as to obtain the red nitride phosphor of the embodiment of the present disclosure.

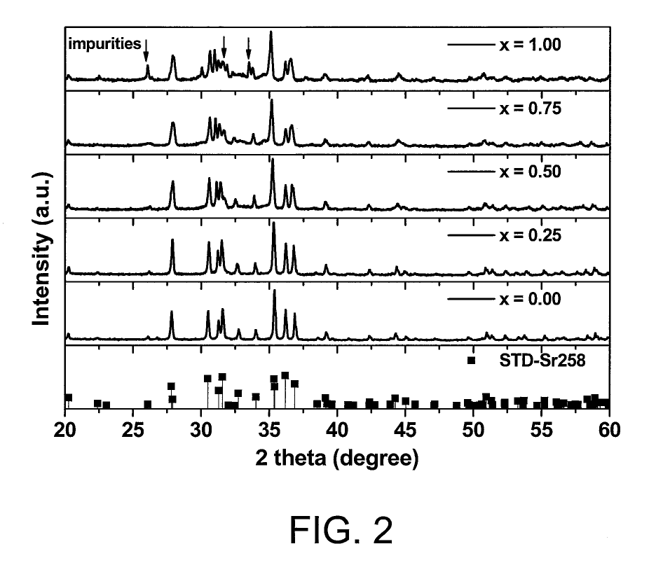

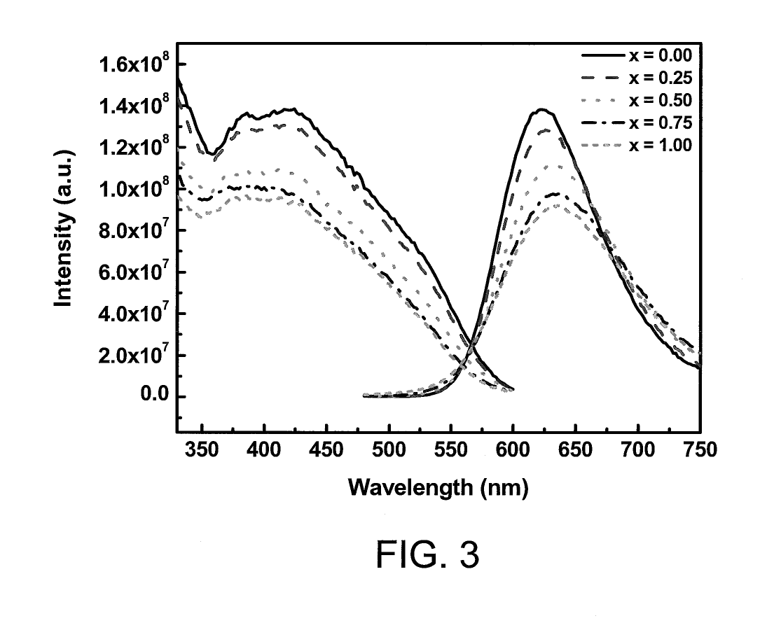

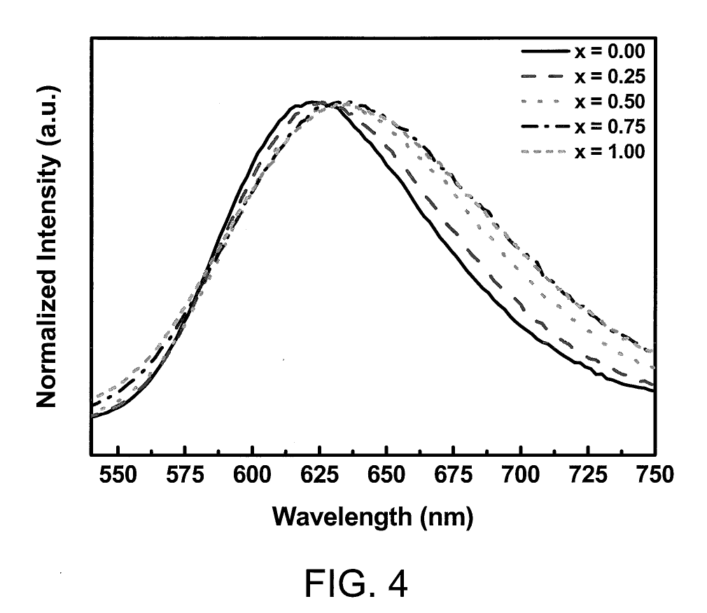

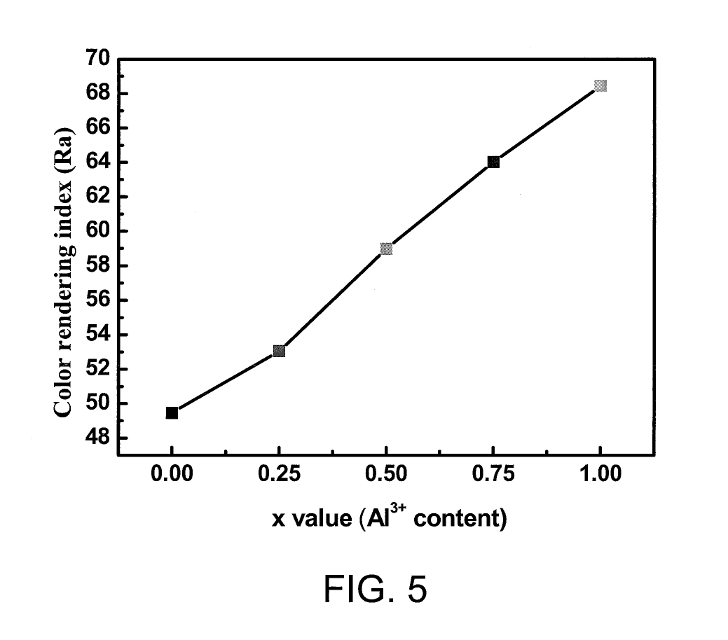

In the following, red nitride phosphors of Comparative Example 1 and Examples 1-4 are synthesized according to the aforementioned preparation method. Moreover, the results of the property evaluations are illustrated in FIGS. 2-5. FIG. 2 shows the X-ray diffraction spectra of the red nitride phosphors according to Comparative Example 1 and Examples 1-4. FIG. 3 shows the excitation and emission spectra of the red nitride phosphors according to Comparative Example 1 and Examples 1-4. FIG. 4 shows the normalized emission spectra of the red nitride phosphors according to Comparative Example 1 and Examples 1-4. FIG. 5 is the CRI diagram of the red nitride phosphors according to Comparative Example 1 and Examples 1-4.

### Comparative Example 1

0.3151 g of Sr₃N₂, 0.3897 g of Si₃N₄ and 0.0138 g of EuN were mixed to form a mixture. Thereafter, the mixture was disposed in a crucible after 30 minutes of mixing and grinding. Afterwards, the crucible was placed in a high temperature furnace with nitrogen under a pressure of about 0.5 MPa and sintered at about 1,600° C. for about 2 hours to obtain a red nitride phosphor of Sr_{1.95}Si₅N₈:Eu_{0.05}. Notice that, in comparative example 1, Al₂O₃ is not added into the mixture.

### Example 1

0.3151 g of Sr₃N₂, 0.3702 g of Si₃N₄, 0.0138 g of EuN and 0.0212 g of Al₂O₃ were mixed to form a mixture. Thereafter, the mixture was disposed in a crucible after 30 minutes of mixing and grinding. Afterwards, the crucible was placed in a high temperature furnace with nitrogen under a pressure of about 0.5 MPa and sintered at about 1,600° C. for about 2 hours to obtain a red nitride phosphor of Sr_{1.95}Si_{4.75}Al_{0.25}N_{7.75}O_{0.25}:Eu_{0.05}.

### Example 2

0.3151 g of Sr₃N₂, 0.3507 g of Si₃N₄, 0.0138 g of EuN and 0.0425 g of Al₂O₃ were mixed to form a mixture. Thereafter, the mixture was disposed in an aluminum oxide crucible after 30 minutes of mixing and grinding. Afterwards, the crucible was placed in a high temperature furnace with nitrogen under a pressure of about 0.5 MPa and sintered at about 1,600° C. for about 2 hours to obtain a red nitride phosphor of Sr_{1.95}Si_{4.5}Al_{0.5}N_{7.5}O_{0.5}:Eu_{0.05}.

### Example 3

0.3151 g of Sr₃N₂, 0.3312 g of Si₃N₄, 0.0138 g of EuN and 0.0637 g of Al₂O₃ were mixed to form a mixture. Thereafter, the mixture was disposed in a crucible after 30 minutes of mixing and grinding. Afterwards, the crucible was placed in a high temperature with nitrogen under a pressure of about 0.5 MPa and sintered at 1,600° C. for 2 hours to obtain a red nitride phosphor of Sr_{1.95}Si_{4.25}Al_{0.75}N_{7.25}O_{0.75}:Eu_{0.05}.

### Example 4

0.3151 g of Sr₃N₂, 0.3117 g of Si₃N₄, 0.0138 g of EuN and 0.0850 g of Al₂O₃ were mixed to form a mixture. Thereafter, the mixture was disposed in a crucible after 30 minutes of mixing and grinding. Afterwards, the crucible was placed in a high temperature furnace with nitrogen under a pressure of about 0.5 MPa and sintered at about 1,600° C. for about 2 hours to obtain a red nitride phosphor of Sr_{1.95}Si₄AlN₇O:Eu_{0.05}.

The physical properties of the red nitride phosphors of Comparative Example 1 and Examples 1-4 are shown in Table 1.

TABLE 1

| | | | Full width | |
|---|---|---|---|---|
| | | Dominant | at half | |
| | x | wavelength | maximum | |
| Sr_{1.95}Si₅₋ₓAlₓN₈₋ₓOₓ:Eu_{0.05} | value | (nm) | (FWHM) (nm) | CRI |
| Comparative Example 1 | 0.00 | 622 | 92 | 49.46 |
| Example 1 | 0.25 | 626 | 100 | 53.05 |
| Example 2 | 0.50 | 632 | 110 | 58.98 |
| Example 3 | 0.75 | 634 | 122 | 64.02 |
| Example 4 | 0.10 | 635 | 123 | 68.44 |

Referring to FIG. 2, the bottom spectrum is a theoretical spectrum for reference, and the X-ray diffraction spectra of the red nitride phosphors of Comparative Example 1 and Examples 1-4 are compared with the theoretical spectrum to identify the crystal phase of the compositions. As shown in FIG. 2, when the x value is ranged from 0.25 to 0.75 (0.25≦x≦0.75), the red nitride phosphors of Examples 1-3 are in pure phase. When the x value is equal to 1.00, the red nitride phosphor of Example 4 is not in pure phase but in mixed phase. The noises of impurity phases would appear when the x value is 1.00 or higher. Therefore, x value is preferably greater to or equal to 0.25 but less than 1.00 (0.25≦x≦1.00).

Referring to FIG. 2, FIG. 3 and Table 1, when the x value is increased (i.e. the addition of Al₂O₃ is more), the emission peak wavelengths of the red nitride phosphors of Comparative Example 1 and Examples 1-4 are shifted toward a long wavelength side (from 622 nm to 635 nm), and the full width at half maximum (FWHM) of the emission peaks are broadened from 92 nm to 123 nm. The trend of FWHM broadening is beneficial to improve the CRI performance of the red nitride phosphors.

Moreover, as shown in FIG. 5, the calculated CRI values are increased by 38% (from 49.46 to 68.44) when the x value is changed from 0.00 to 1.00. Specifically, as compared with the red nitride phosphor without addition of Al₂O₃ (Comparative Example 1), the red nitride phosphors with addition of Al₂O₃ (Examples 1-4) exhibit higher CRI values. This is because that the crystal structure of the red nitride phosphor is transformed by addition of Al₂O₃. In other words, the crystal structure capable of emitting red light is obtained by addition of Al₂O₃. Referring to FIG. 4, the emission spectrum is shifted toward the right area (red spectrum), therefore, the amount of emitted red light is increased as well as the CRI values is also increased.

In summary, the red nitride phosphor of the present disclosure has a CRI of greater than 50 and is suitable to be applied in a white LED to improve the color rendering property of the white light.

Further, in the method of the present disclosure, an appropriate amount of Al₂O₃ are added to the red nitride phosphor precursors, and the mixture are mixed up and then sintered to form the red nitride phosphor of the present disclosure. The method is simple and can be implemented for mass production. Accordingly, the red nitride phosphor of the present disclosure has a competitive advantage in the industry.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

1. A phosphor represented by following chemical formula (1):
A₂₋ₘB₄CD₇E:Mₘ (1),
wherein
M represents at least one activator selected from Mn, Ce, Pr, Nd, Sm, Eu, Tb, Dy, Ho, Er, Tm, Yb, and combinations thereof;
A represents at least one element selected from Ca²⁺, Sr²⁺, Ba²⁺, and combinations thereof;
B represents C⁴⁺, Si⁴⁺, or Ge⁴⁺;
C represents B³⁺, Al³⁺, or Ga³⁺; and
D and E each independently represent at least one element selected from N, O, F, and combinations thereof; wherein
0.00001≦m≦0.05.

2. The phosphor of claim 1, wherein the phosphor is represented by following chemical formula (2):
Sr_{1.95}Si₄AlN₇O:Eu_{0.05} (2).

3. (canceled)

4. The phosphor of claim 1, wherein a color rendering index (CRI) of the phosphor is greater than about 50 and less than about 70.

5. The phosphor of claim 1, wherein the phosphor is excited by a first light having a dominant wavelength of about 350-550 nm to emit a second light.

6. The phosphor of claim 5, wherein the second light comprises a dominant wavelength of about 550-750 nm and a full width at half maximum (FWHM) of about 90-130 nm.

7. The phosphor of claim 5, wherein the second light comprises a dominant wavelength of about 626-635 nm and a FWHM of about 100-123 nm.

8. A method of preparing a phosphor, comprising steps of:
providing a mixture comprising precursors of Sr, Si, Eu, and Al;
mixing and grinding the mixture; and
performing a sintering process to the mixture with inert gas under an atmosphere after being mixed and ground, so as to form a phosphor represented by following chemical formula (2):
Sr_{1.95}Si₄AlN₇O:Eu_{0.05} (2).

9. The method of claim 8, wherein the step of providing the mixture further comprises providing Sr₃N₂, Si₃N₄, EuN, and Al₂O₃.

10. The method of claim 8, wherein a sintering temperature is about 1,400-1,900° C. during the sintering process.

11. The method of claim 8, wherein a sintering time is about 1-5 hours during the sintering process.

12. The method of claim 8, wherein the pressure of the inert gas is about 0.3-0.9 MPa during the sintering process.

13. The method of claim 8, wherein a sintering temperature is about 1,600° C., a sintering time is about 2 hours, and an inert gas pressure is about 0.5 MPa during the sintering process.

14. The method of claim 8, wherein a color rendering index (CRI) of the phosphor is greater than about 50 and less than about 70.

15. The method of claim 8, wherein the phosphor is excited by a first light having a dominant wavelength of about 350-550 nm to emit a second light.

16. The method of claim 15, wherein the second light comprises a dominant wavelength of about 550-750 nm and a full width at half maximum (FWHM) of about 90-130 nm.

17. The method of claim 15, wherein the second light comprises a dominant wavelength of about 626-635 nm and a FWHM of about 100-123 nm.
